(19) United States
(12) Patent Application Publication
(10) Pub. No.: US 2012/0311976 A1
(43) Pub. Date: Dec. 13, 2012

(54) HORSE TRAINING HALTER

(75) Inventor: Bruce Voigt, Big Bear Lake, CA (US)

(73) Assignee: MANE HORSEMANSHIP, INC., Big Bear Lake, CA (US)

(21) Appl. No.: 13/156,631

(22) Filed: Jun. 9, 2011

(51) Int. Cl. B68B 1/02

(52) U.S. Cl. 54/24

(57) ABSTRACT

The horse halter includes a noseband and chin strap each connected at both their ends. A poll strap and throat strap are each connected at both their ends. A pair of cheek straps are each connected at one end to the noseband and chin strap and are connected at the other end to the poll strap and throat strap. A jaw strap is connected between a middle of the chin strap and a middle of the throat strap. The chin strap and poll strap each include a resiliently elastic material. The noseband, the pair of cheek straps, jaw strap and throat strap each include a substantially non-resiliently elastic material. The poll strap may include an adjustment means or a buckle for changing the length of the poll strap.

### FIELD OF THE INVENTION

The present invention generally relates to horse halters. More particularly, the present invention relates to a horse halter which increases pressure slowly on the horse but immediately releases pressure when the horse succumbs to the trainer's command.

### BACKGROUND OF THE INVENTION

Horse halters, also called bridles or head harnesses, are devices placed on the heads of saddle and draft animals, usually horses, which are used to guide and lead the horse. They customarily are made of a framework of leather straps to fit on the horse's head, the so-called head harness/halter. The head halter typically consists of a browband running across the brow and a poll strap (crown piece/headband), which runs down behind the ears and in certain cases is provided with a throat strap. Usually a head harness of this type has a bit (a snaffle bit or curb bit), but there are also bridles without bits, so-called stable halters, which a horse wears while at rest. Stable halters of this type are typically not used to direct or guide a horse.

One of the most difficult aspects in dealing with a horse is maintaining control over the horse, so that the horse remains responsive and manageable to trainer commands and instructions. While there are a variety of training methods and apparatus known throughout the world for training a horse, current methods and apparatus suffer several drawbacks. Most apparatus for controlling horses utilize restraints or harnesses of some type which forcibly engage the head or mouth, or both. With such apparatus, the trainer must physically overpower an uncooperative animal.

Accordingly, there is a need for a horse halter that is humane but also helps to teach a horse quicker than existing halters by slowly increasing pressure behind the ears and quickly releasing the pressure when the horse succumbs to the trainer's direction. The present invention fulfills these needs and provides other related advantages.

### SUMMARY OF THE INVENTION

In an exemplary embodiment, the horse halter of the present invention includes a noseband and chin strap each connected at both their ends. A poll strap and throat strap are each connected at both their ends. A pair of cheek straps are each connected at one end to the noseband and chin strap and are connected at the other end to the poll strap and throat strap. A jaw strap is connected between a middle of the chin strap and a middle of the throat strap. The chin strap and poll strap each include a resiliently elastic material. In another exemplary embodiment, the noseband, the pair of cheek straps, jaw strap and throat strap includes a substantially inelastic material. The horse halter helps to train a horse quicker by slowly increasing pressure behind a horse's ears through the resiliently elastic chin strap and poll strap when the chin strap is pulled by a trainer's direction. Then, the horse halter quickly releases the pressure when the horse succumbs to the trainer's direction. The second the horse gives in to the pressure, the pressure is immediately released through the elastic material and therefore does not rely on the trainer's experience to properly apply the pressure. In this way the horse learns quicker as compared to traditional halters.

An exemplary embodiment includes a first and second connector connecting the noseband, the pair of cheek straps and chin strap. A third and fourth connector connect the poll strap, the pair of cheek straps and the throat strap. A fifth connector connects the jaw strap to the middle of the chin strap. A sixth connector connects the jaw strap to the middle of the throat strap.

A lead rope may be connected to the fifth connector. Furthermore, a pair of reins may be connected to the third and fourth connectors.

The chin strap may include a left and right chin strap, or be fashioned as a single part. The first, second, third, fourth and fifth connectors may include rings or various other connecting designs.

To increase adjustability of the halter for varying sizes, the poll strap may include an adjustment means for changing the length of the poll strap. The adjustment means may include a buckle for changing the length of the poll strap.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of an exemplary horse halter embodying the present invention;

FIG. 2 is a perspective view of the structure of FIG. 1 now fitted on a horse's head;

FIG. 3 is a side view of the structure of FIG. 1 now fitted on a horse's head;

FIG. 4 is another side view of the structure of FIG. 1 now fitted on a horse's head with a lead rope pulling down;

FIG. 5 is a top view of the structure of FIG. 1 now fitted to a horse traveling in a circle; and

FIG. 6 is a close-up of the horse of FIG. 5 showing the horse's head turned inward.

### DETAILED DESCRIPTION OF THE PREFERRED EMBODIMENTS

As shown in the drawings for purposes of illustration, the present invention for a horse halter is referred to generally by the reference number 10.

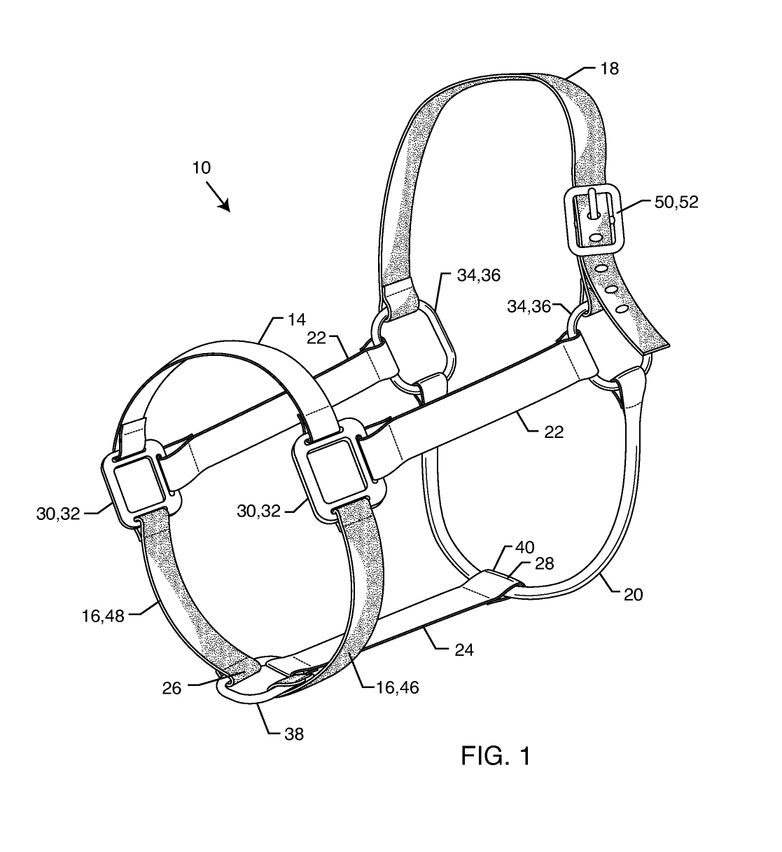

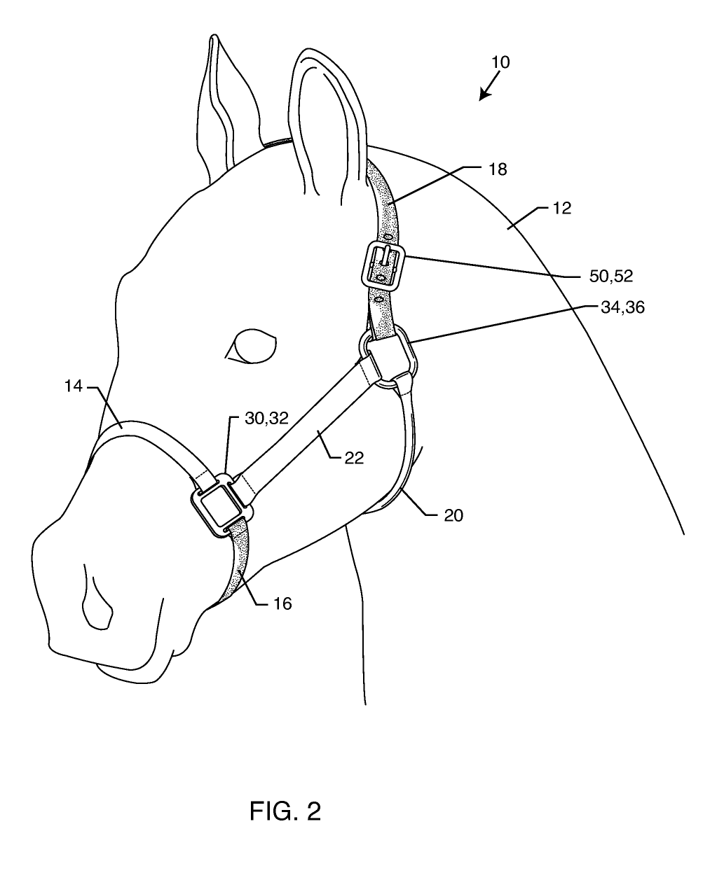

FIG. 1 is a perspective view of an exemplary horse halter 10 embodying the present invention. FIG. 2 is a perspective view of the structure of FIG. 1 now fitted on a horse's head 12. In an exemplary embodiment, the horse halter 10 includes a noseband 14 and chin strap 16 each connected at both their ends. A poll strap 18 and throat strap 20 are each connected at both their ends. A pair of cheek straps 22 are each connected at one end to the noseband 14 and chin strap 16 and are connected at the other end to the poll strap 18 and throat strap 20. A jaw strap 24 is connected between a middle 26 of the chin strap 16 and a middle 28 of the throat strap 20.

The chin strap 16 and poll strap 18 each include a resiliently elastic material. The resiliently elastic material can stretch and return to its original shape. As the elastic material stretches, it imparts more force onto the horse's head 12. The force is applied slowly from the trainer when a rope is connected to the halter 10. The force is applied slowly to the horse's head 12 and is quickly relieved when the horse succumbs to the trainer's direction. In this way the horse quickly learns to give in to the trainer's directions. As can be seen by one skilled in the art, a multitude of materials can be used which are resiliently elastic, as this disclosure is not intended to limit it to any one precise form. For instance, the elastic material can include a heavy duty nylon elastic nylon.

Furthermore, in another exemplary embodiment the noseband 14, the pair of cheek straps 22, jaw strap 24 and throat strap 20 all include a substantially inelastic material. This then allows just the poll strap 18 and the chin strap 16 to give elastically.

There are several advantages of the present invention. When a horse is tied up the halter 10 helps to teach a horse not to pull back. When a horse does pull back, it applies pressure slowly behind the ears of the horse. The second the horse gives to the pressure, or comes forward, the pressure releases immediately. Also, when lunging a horse, the halter 10 allows for pressure to come on slow and off fast which then helps the horse to learn faster. This is also helpful when bumping a horse to get the head to turn towards the trainer. Finally, the halter 10 helps novice trainers, as the pressure is released on the horse the second the horse gives in to the trainer's direction. This then means the trainer does not have to be an expert trainer to successfully and quickly train the horse.

An exemplary embodiment may also include a first and second connector 30,32 connecting the noseband 14, the pair of cheek straps 22 and chin strap 16. A third and fourth connector 34,36 connect the poll strap 18, the pair of cheek straps 22 and the throat strap 20. A fifth connector 38 connects the jaw strap 24 to the middle 26 of the chin strap 16. A sixth connector 40 connects the jaw strap 24 to the middle 28 of the throat strap 20. The connectors (30, 32, 33, 34, 36, 38 and 40) can be formed in a variety of styles and designs. For instance, connectors 34 and 36 are rings where the straps are sewn around them. Connectors 30 and 32 have slots formed therein for the straps to pass there through. Connector 40 is formed merely by creating a loop at the end of the jaw strap 24 which encircles the throat strap 20. As can be seen by one skilled in the art, a variety of connectors can be utilized as this disclosure is not intended to limit it to the precise forms disclosed and shown herein.

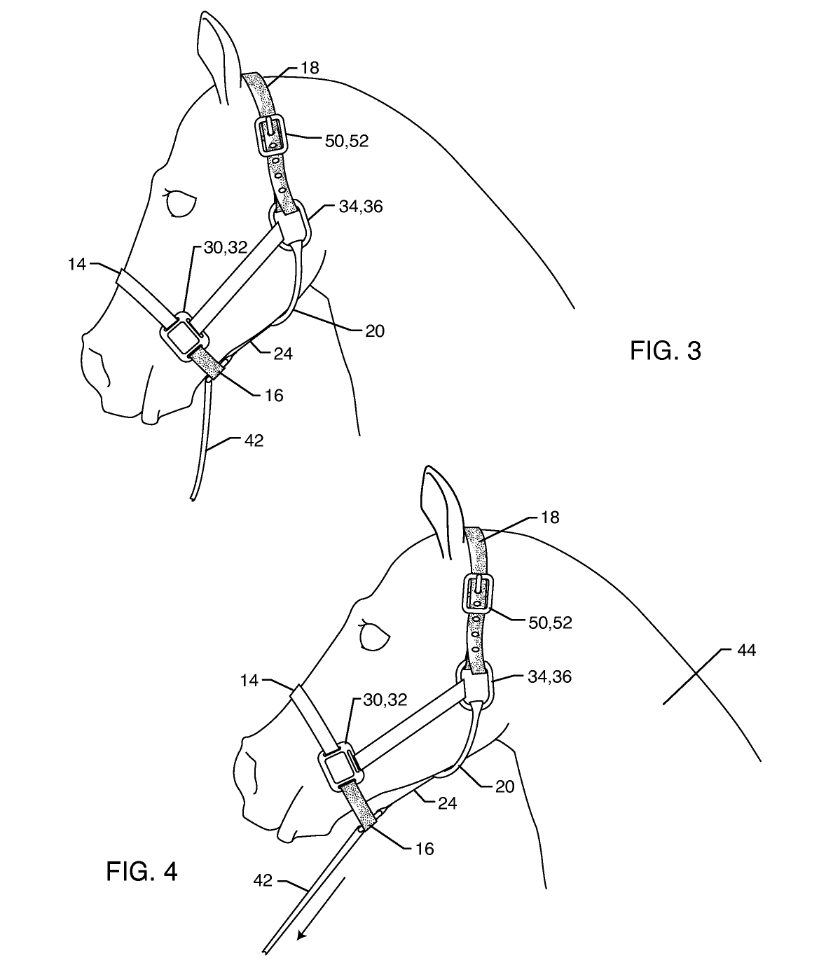

FIG. 3 is a side view of the structure of FIG. 1 now fitted on a horse's head 12 and FIG. 4 is another side view of the structure of FIG. 1 now fitted on a horse's head 12 with a lead rope 42 pulling down. The lead rope 42 may be connected to the fifth connector 38. The chin strap 16 may include a left 46 and right 48 chin strap 16, or be fashioned as a single part.

To increase adjustability of the halter 10 for varying sizes, the poll strap 18 may include an adjustment means 50 for changing the length of the poll strap. The adjustment means 50 may include a buckle 52 for changing the length of the poll strap 18.

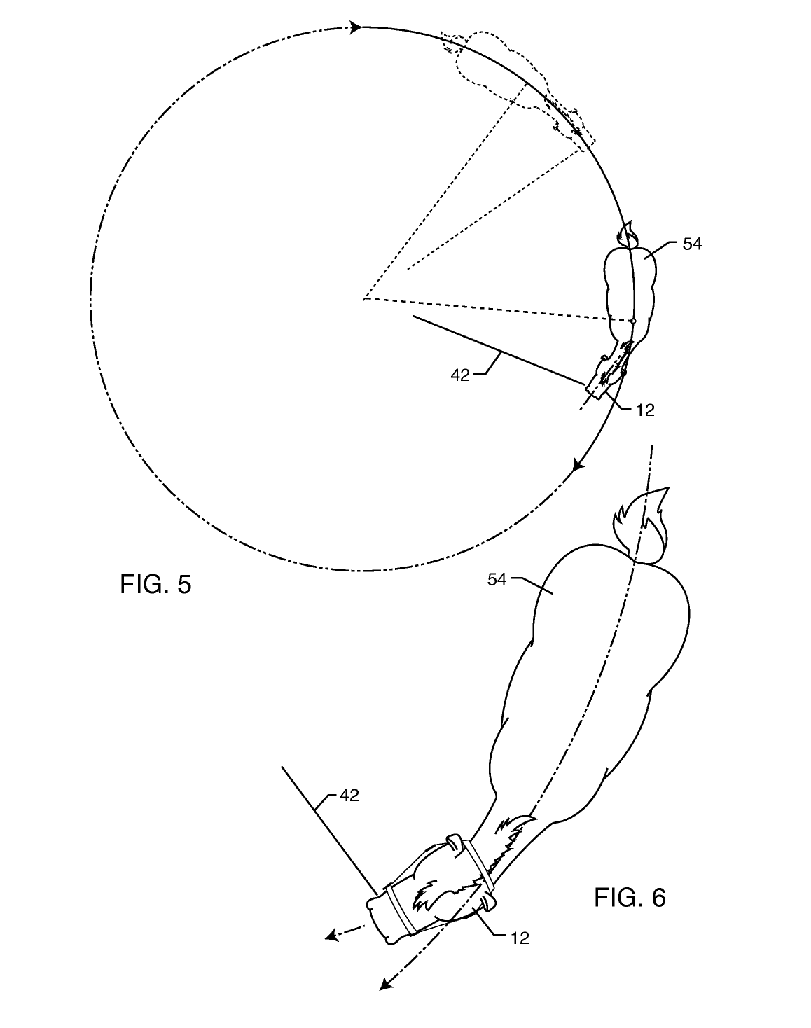

FIG. 5 is a top view of the structure of FIG. 1 now fitted to a horse 54 traveling in a circle and FIG. 6 is a close-up of the horse 54 of FIG. 5 showing the horse's head 12 turned inward. The halter 10 applies pressure slowly such that the horse 54 learns to succumb to the pressure and succumb to the trainer's direction. If the horse 54 resists, the pressure increases and become uncomfortable. If the horse 54 succumbs the pressure immediately releases and the horse 54 no longer has any discomfort.

Although several embodiments have been described in detail for purposes of illustration, various modifications may be made to each without departing from the scope and spirit of the invention. Accordingly, the invention is not to be limited, except as by the appended claims.

What is claimed is:

1. A horse halter conforming to a horse's head, comprising:
a noseband and chin strap each connected together at both ends;
a poll strap and throat strap each connected together at both ends;
a pair of cheek straps each connected at one end to the noseband and chin strap and connected at the other end to the poll strap and throat strap;
a jaw strap connected between a middle of the chin strap and a middle of the throat strap; and
wherein the chin strap and poll strap comprise a resiliently elastic material, such that the horse halter helps to train a horse quicker by slowly increasing pressure behind a horse's ears through the resiliently elastic chin strap and poll strap when the chin strap is pulled by a trainer's direction and by quickly releasing the pressure when the horse obeys the trainer's direction.

2. The halter of claim 1, wherein the noseband, the pair of cheek straps, jaw strap and throat strap comprise a substantially inelastic material.

3. The halter of claim 2, including a first and second connector connecting the noseband, the pair of cheek straps and chin strap.

4. The halter of claim 3, including a third and fourth connector connecting the poll strap, the pair of cheek straps and the throat strap.

5. The halter of claim 4, including a fifth connector connecting the jaw strap to the middle of the chin strap.

6. The halter of claim 5, including a sixth connector connecting the jaw strap to the middle of the throat strap.

7. The halter of claim 6, including a lead rope connected to the fifth connector.

8. The halter of claim 7, wherein the chin strap comprises a left and right chin strap.

9. The halter of claim 8, wherein the first, second, third, fourth and fifth connectors comprise rings.

10. The halter of claim 2, wherein the poll strap comprises an adjustment means for changing the length of the poll strap.

11. The halter of claim 10, wherein the adjustment means comprises a buckle for changing the length of the poll strap.

12. A horse halter conforming to a horse's head, comprising:
a noseband and chin strap each connected at both their ends;
a poll strap and throat strap each connected at both their ends;
a pair of cheek straps each connected at one end to the noseband and chin strap and connected at the other end to the poll strap and throat strap;
a jaw strap connected between a middle of the chin strap and a middle of the throat strap; and
wherein the chin strap and poll strap comprise a resiliently elastic material and where the noseband, the pair of cheek straps, jaw strap and throat strap comprise a substantially inelastic material.

13. The halter of claim 12, wherein the poll strap comprises an adjustment means for changing the length of the poll strap.

14. The halter of claim 13, wherein the adjustment means comprises a buckle for changing the length of the poll strap.

15. The halter of claim 14, including a first and second connector connecting the noseband, the pair of cheek straps and chin strap, and including a third and fourth connector connecting the poll strap, the pair of cheek straps and the throat strap.

16. The halter of claim 15, including a fifth connector connecting the jaw strap to the middle of the chin strap and a sixth connector connecting the jaw strap to the middle of the throat strap.

17. The halter of claim 16, including a lead rope connected to the fifth connector.
